(19) United States
(12) Patent Application Publication
(10) Pub. No.: US 2006/0127869 A1
(43) Pub. Date: Jun. 15, 2006

(54) Advertising subsystem for the educational software market

(75) Inventors: Edward M. Fields, Los Gatos, CA (US); Steven B. Bowler, Hudson, MA (US)

Correspondence Address: STEVENS LAW GROUP, P.O. BOX 1667, SAN JOSE, CA, 95109, US

(73) Assignee: HotChalk, Inc., Los Gatos, CA (US)

(21) Appl. No.: 11/303,808

(22) Filed: Dec. 15, 2005

Related U.S. Application Data
(60) Provisional application No. 60/636,691, filed on Dec. 15, 2004.
(60) Provisional application No. 60/681,895, filed on May 16, 2005.

(51) Int. Cl. G09B 3/00

(52) U.S. Cl. 434/350

(57) ABSTRACT

A system and method are provided for delivering advertising to school administrators, teachers, parents, and students that includes module configured for managing advertisements on a website; reviewing advertising for appropriate content; marketing website space to advertisers; receiving submitted advertisements for publication; accepting advertisements according to predetermined educational based criteria; and storing demographical data for all users of the application.

### RELATED APPLICATIONS

This application claims priority based on U.S. Provisional Application No. 60/636,691, filed on Dec. 15, 2004 and U.S. Provisional Application No. 60/681,895 filed on May 16, 2005.

### BACKGROUND

The importance of fundraising activities in public schools is well known. A nationwide survey revealed that over 90 percent of public schools participate in fundraisers to raise supplemental funds. Over 82 percent have seen an increased need for fundraising over the past 10 years. Money from fundraisers is most often used for classroom equipment and supplies, field trips, library books, and playground equipment. However, the same survey revealed that almost 70 percent of the school administrators would prefer to stop fundraising activities at their schools if it were possible. Often they are disruptive to the educational process, stressful on the students and parents, and have to be repeated throughout the school year.

Also well known is the influence of advertising on children. Many studies have been conducted that clearly demonstrate how advertisers have been increasing the amount of marketing geared to children. In 1990, $100 million was spent on advertising to children in America. By 2000, that figure had increased to $2 billion. Unfortunately, much of this advertising is not filtered and exposes children to inappropriate and sometimes harmful messages. Marketers of teen movies and video games pursue children by advertising violent action toys. Additionally, music with explicit lyrics is advertised on TV, radio, print and online venues popular with teens. A variety of studies have found a substantial relationship between children's viewing of tobacco and alcohol ads and positive attitudes toward consumption of such products. Children find many such commercials attractive and consequently have high brand awareness of such products and positive attitudes toward them. These products and their spokes-characters (e.g., Joe Camel, the Budweiser frogs) have been found to be featured in programming and publications frequently viewed by minors, and research has consistently concluded that the advertising of them contributes to youth smoking and drinking.

Accordingly, there is a need to review the content of advertisements accessible to school age children. Furthermore, it is desirable to find an alternative to fundraising that will support the financial needs of the schools. As will be seen, the invention handles this in an elegant manner.

### BRIEF DESCRIPTION OF THE DRAWINGS

FIG. 1 is a flow chart illustrating one method according to the invention.

FIG. 2 is a flow chart illustrating one method according to the invention.

FIG. 3 is a flow chart illustrating one method according to the invention.

FIG. 4 is a diagrammatic view of a system illustrating one method according to the invention.

FIG. 5 is a flow chart illustrating one method according to the invention.

FIG. 6 is a flow chart illustrating one method according to the invention

### DETAILED DESCRIPTION

In addressing the problems of the prior art, the invention is directed to a system which may be part of an educational content software package, wherein advertising from national and local merchants may be included as a means of providing financial support to the schools. Among the benefits to the schools is the ability to raise revenue with minimal investment of time or money. As a fundraising activity, the schools may auction off advertising space on its website. Merchants bid for advertising space, time, and audience, and the proceeds from the auction go to the school. In one embodiment, the system may track a merchant's success from advertising at a particular school. As part of the auction package, the merchant may bid on additional proceeds to give to the school that has the highest success rate for that advertisement. The school community also benefits from the ability to select what advertising content will be appropriate for the school community. Furthermore, the schools, students, teachers, and parents benefit from a safe environment for education while receiving advertisements from local and national merchants for useful products and services. Merchants also benefit from being able to leverage their ads to captive audiences of various demographical markets. Another benefit to merchants is the ability to passively market their goods and services to young people, their parents, and teachers, while receiving large amounts of data on their preferences and buying habits.

The invention provides a system for reviewing advertising to determine appropriate content for and accepting advertisements according to predetermined educational based criteria. In one embodiment, the criteria may be to promote and encourage the educational success of the student. Sponsors advertising tutorial or learning assistance services, such as posting Sylvan Learning Centers™, may be given a priority approval. In this embodiment, the system may identify students whose grades are below a predetermined level of acceptance. The system may select from approved learning assistance advertisements that match the subject matter and grade level of the student and posts those advertisements to both the student's computer and the student's parent's or guardian's computer. Furthermore, the system may identify students whose grades exceed a predetermined level of excellence. The system may select from approved reward advertisements to post to both the student's computer and the student's parent's or guardian's computer. The reward advertisements selected may be appropriate for the student's grade level and achievement. For example, a younger student may receive an advertisement that includes a coupon for free ice cream, while an older student may receive an advertisement with a coupon for a free movie pass, or a coupon at a local business. Additionally, advertisements promoting discounts for good grades on items such as auto insurance may be sent to students and their parents or guardians.

In one embodiment, the invention may also include a downloadable navigation bar that may be user specific. In this embodiment, users of the application would be required to be registered. The registration form for students may include name, school, and grade. Parents and guardians may be linked to particular students through their registration form, and teachers may be linked to a particular grade. Upon successful registration, the user may be given a username and password to log into the system, and may download the navigation bar for the website. Additionally, the registration form may include demographical data about the user such as age, gender, geographical information, and interests. Sponsors could use this information to submit advertisements directed to a specific audience. Furthermore, the advertisements submitted for inclusion may be reviewed by local administrators for appropriate content prior to their inclusion on the school's website. In one embodiment, if a sponsor such as a local merchant who normally does not advertise over the Internet wants to submit an advertisement but does not have one, the application may include the tools to allow the sponsor to create a simple banner by logging into the application and responding to a query for general information such as name, address, operating hours, products or services offered, etc.

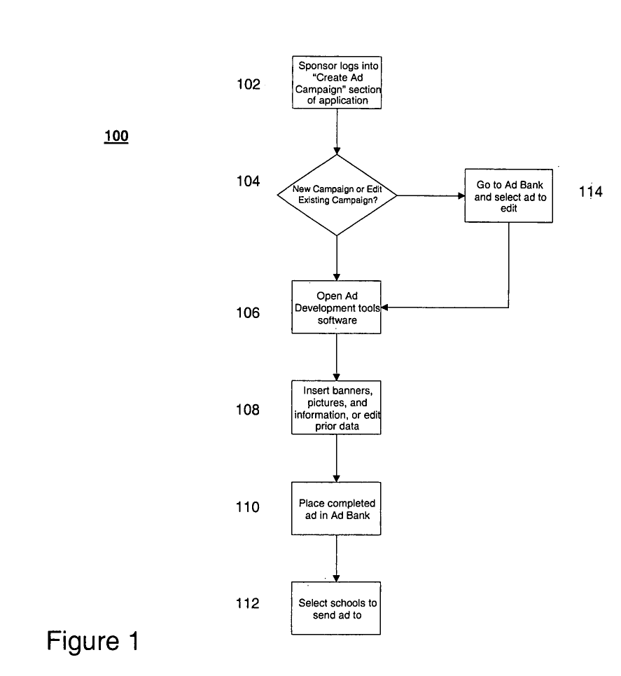

Referring to FIG. 1, a sponsor might log into a create ad campaign section of the application 102, and select whether he or she wants to create a new advertisement or edit a previously submitted ad, 104. If the sponsor is editing an existing advertisement, the application will redirect the sponsor to the ad bank database to select from all advertisements previously submitted by the sponsor, 114. The sponsor may then open the ad development tools window, 106. After completing the information query, the sponsor may then customize the advertisement by adding banners, pictures, or other graphics to the ad, 108 and then post the completed advertisement to the ad bank database, 110. Sponsors would then be queried to select what schools or school systems they would like to place their advertisement in, 112. In one embodiment, the sponsor may review analytical data of participating schools and school systems to identify desired target audiences and historical data such as the success rate of various types of marketing strategies at those schools.

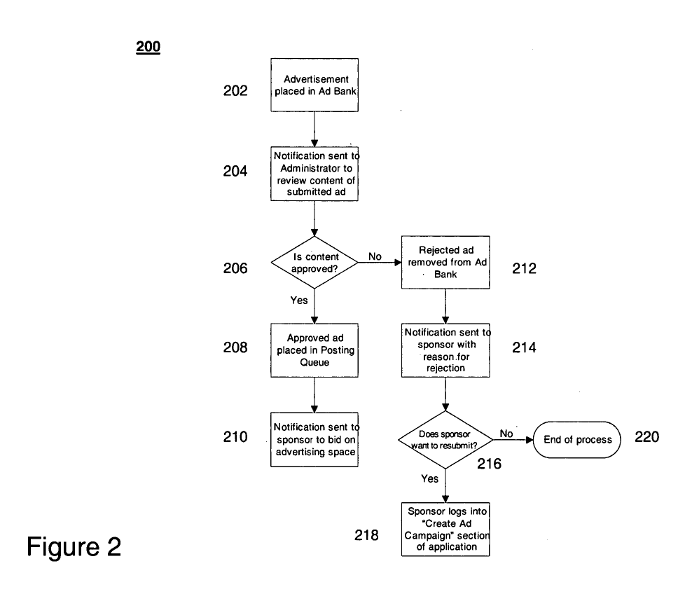

Referring to FIG. 2, after an advertisement has been posted to the ad bank database 202, the database may send a notification to the selected schools that a new advertisement has been posted for their review, 204. Administrators of the school or school system website may then review the content of the advertisement for appropriate content and subject matter, 206. In one embodiment, the administrators of the website may be a committee of parents, teachers, or community members representing a cross-section of the local population in the school district. In another embodiment, the application may have built-in screening software that automatically searches for keywords or language type. If the advertisement is approved, the ad may be placed in the posting queue database, 208 and a notification is sent to the sponsor, 210 that they may proceed to bid for advertisement space on the school websites where the advertisement was approved. If the advertisement is rejected, the rejected ad is removed from the ad bank database, 212 and a notification is sent to the sponsor advising them of the reason or reasons for rejection, 214. The sponsor may then decide if they want to revise and resubmit their advertisement, 216. If the sponsor does want to resubmit the ad, the sponsor may download the original ad back to the ad bank database and log into the create ad campaign section of the application, 218. If the sponsor does not wish to resubmit the advertisement, the sponsor may delete the ad, 220.

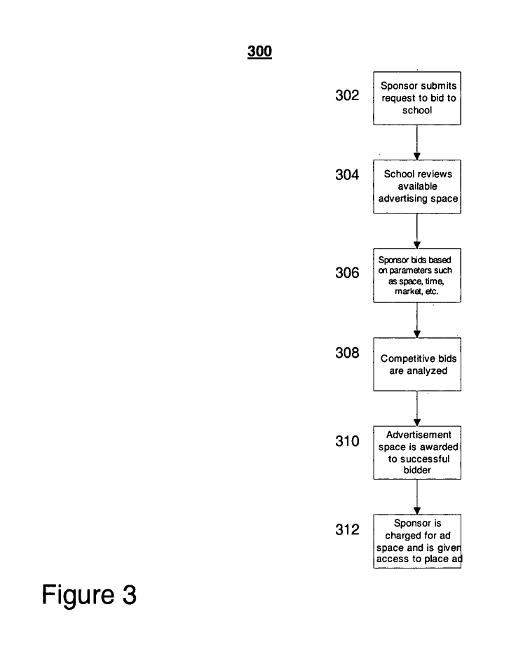

Referring to FIG. 3, after a sponsor submits a request to a school to bid on advertising space, 302 the school may review the status of advertisement space available on its website and open its auction site up to accept bidding. In another embodiment, the school information system application may continuously monitor the site for open advertisement space. If advertising space is available, the school may query the advertisement posting queue database for available sponsors and send out a request to bid notice to sponsors approved for their site. Furthermore, in another embodiment, the school information system may be instructed to create additional advertising space on the website if school administrators have a need to raise additional revenue for the school. Sponsors bidding for advertising space may define the ad placement parameters of the advertisement they are bidding on when submitting their bid, 304. In one embodiment such parameters may include required duration of the ad, space requirements, target audience for the advertisement, and time of day the advertisement will appear. In another embodiment, sponsors may bid for exclusive access to any of the defined parameters. After a preset time, the application stops accepting bids. An analysis of all bids is conducted to assess the placement parameters of the submitted ads to the availability of advertising space on the website, 308. Furthermore, in one embodiment, the auction application may include an algorithm that may calculate the market value of exclusive ad space for reference that may be used in analyzing the competitive bids. Successful sponsors are awarded available advertisement space on the website, 310. The sponsor is charged for its successful bid, and given access to the website to place the sponsor's ad, 312.

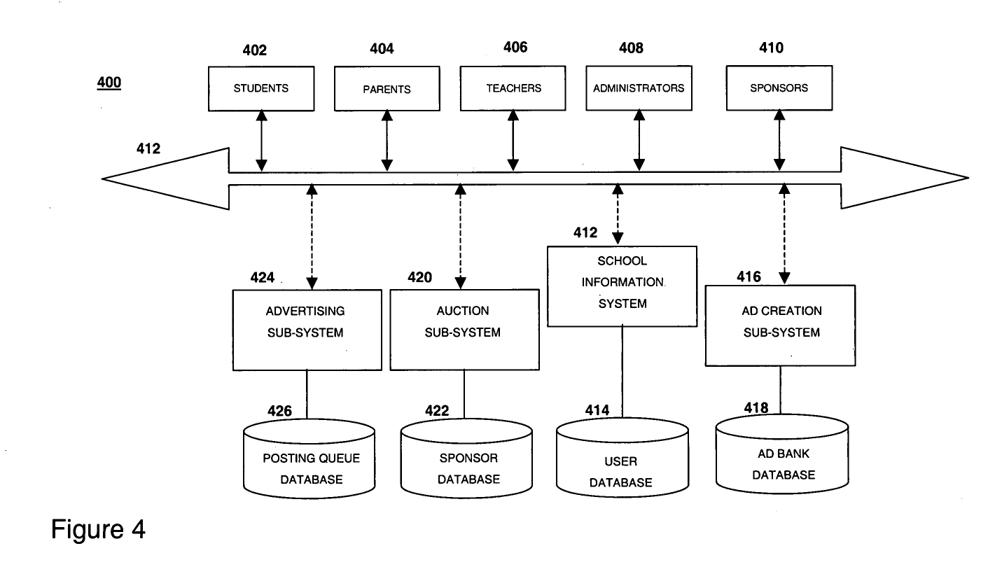

In FIG. 4, one embodiment of a system configured according to the invention is illustrated. In this embodiment, the Internet 412 is the preferred method of delivering information to a plurality of users, 402-410. Students, parents, teachers, and administrators 402-408, are registered users in the school information system application, 412. When users register to use the system, they may provide certain demographical data about themselves, such as age, gender, nationality, and geographical data. Users may also be asked to answer questions regarding likes, dislikes, and interests. This information may be stored in the school information system database, 414. This data may be used by registered sponsors to develop marketing strategies for different schools. In one embodiment, sponsors may identify specific user groups for the application to deliver the advertisement to. For example, a local florist may bid to place an advertisement to be viewed only by adult males for a week before Valentine's Day. In this embodiment, when a user logs into the system, the database checks the user's profile, and if there is a match to the criteria specified by the sponsor in the sponsor database, 422, the advertising sub-system, 424, queues the posting queue database, 426 to upload the advertisement to the user's computer. In another embodiment, users may have the option of turning the advertisement off. The interactive environment of the invention promotes collaboration between administrators, sponsors, and other users of the application. Collaboration between administrators and sponsors ensures that only advertisements that are of appropriate content based on local community standards are accessible to users of the system. Users may provide both direct and indirect feedback to sponsors. In one embodiment, the sponsors, 422 may attach surveys to their advertisements to collect data on the success of their ads. In another embodiment, the school information system database 414, may collect data such as how often users log into the system, what time is most popular with particular user groups, etc. Again this data benefits sponsors when developing effective marketing strategies.

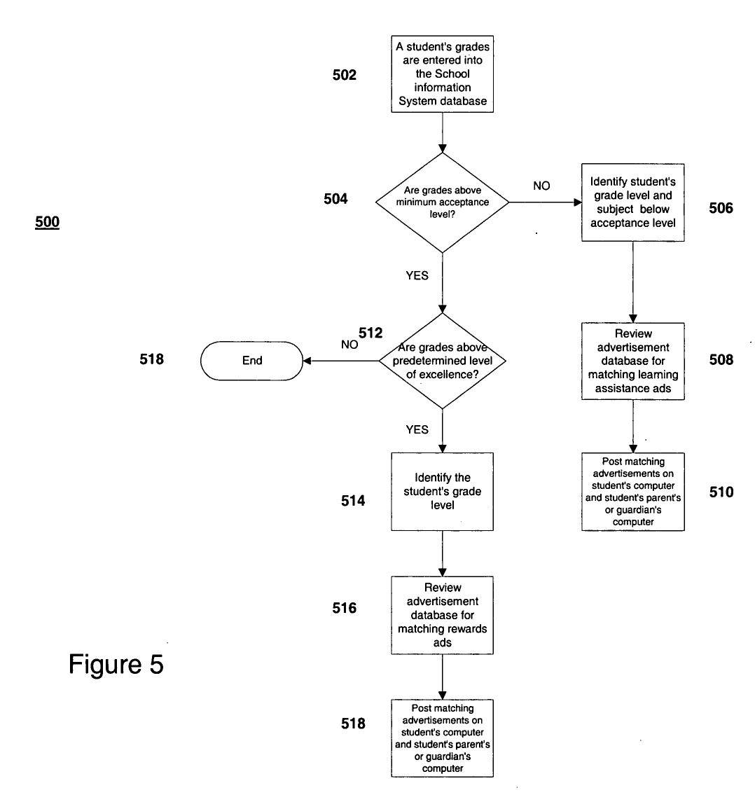

In FIG. 5, one embodiment of a system configured according to the invention to link advertising to academic success is shown. In this embodiment, the student's grades are entered into the school information system database, 502. The database compares the student's grades to a predetermined minimum level of acceptance, 504. If the student's grades are below the minimum, the system identifies what subject the student is below acceptable in, and the student's grade level, 506. The system then matches this information to advertisements in a learning assistance section of the posting queue database for approved advertisements, 508. A notification is sent to the student and the student's parents or guardians, and the selected advertisements offering educational assistance are posted to their computers, 510. For example, ads for tutoring services in a particular subject may be posted.

If the student's grades are above the minimum level of acceptance, 504, the database compares the grades to a predetermined level of excellence, 512. If the student's grades are above excellence, the system identifies the student's grade level, 514. The system then matches this information to advertisements in a rewards section of the posting queue database for approved advertisements, 516. A notification is sent to the student and the student's parents or guardians, and the selected rewards advertisements are posted to their computers, 518. For example, an ad may be posted for free ice cream at a local vendor for such an accomplishment. Or, perhaps an insurance company may post an ad that states “Click here for the Good Driver/Good Student discount auto insurance.”

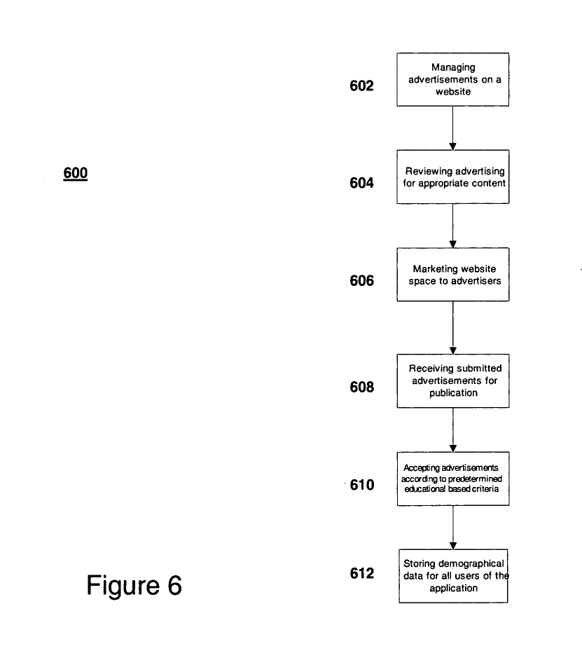

Referring to FIG. 6, a general method configured according to the invention is illustrated showing the steps of managing advertisements on a website 602; reviewing advertising for appropriate content 604; marketing website space to advertisers 606; receiving submitted advertisements for publication 608; accepting advertisements according to predetermined educational based criteria 610; and storing demographical data for all users of the application 612.

Of course, those skilled in the art will understand that the processes in these particular embodiments are not necessarily mutually exclusive, and that the invention is not limited to any particular process or set of applications, but extends to the scope of the appended claims and their equivalents.

1. A system for delivering advertising to school administrators, teachers, parents, and students comprising:
a plurality of user interfaces for students, parents, and educators;
a system for creating or editing advertisements;
a system for reviewing advertising to determine appropriate content for and accepting advertisements according to predetermined educational based criteria;
a system for marketing website space to advertisers; and
a database configured for submitting an advertisement for publication and storing approved advertisements and demographical data for all users of the application.

2. A system according to claim 1, wherein a user ID and password may be required.

3. A system according to claim 1, wherein the advertisements may be created for sponsors automatically by the application based on the sponsor's responses to a query of information.

4. A system according to claim 1, wherein the advertisements may be created for sponsors automatically by the application based the judgement of a representative designated by a school.

5. A system according to claim 1, wherein the advertisements submitted are reviewed by a committee.

6. A system according to claim 1, wherein the advertisements submitted are reviewed by a committee that consists of at least one each of school officials, teachers, parents, guardians and other individuals making up a cross-representation of the local population where the advertisements may be viewed.

7. A system according to claim 5, wherein the sponsor is automatically notified of any rejections of their advertisements. Furthermore, the notification may include the reasons for any rejection.

8. A system according to claim 7, wherein any sponsor whose advertisement has been rejected may be given the opportunity to revise and resubmit their advertisement.

9. A system according to claim 1, wherein the demographical data may be shared with sponsors.

10. A system according to claim 1, wherein the demographical data may be used to individualize advertising distributed to specific users or user groups.

11. A system according to claim 1, wherein the demographical data may be used to collect data that measures the success of particular marketing strategies.

12. A system according to claim 1, wherein the demographical data may also include a student's scholastic information.

13. A system according to claim 1, wherein the advertisements may be turned off automatically at predetermined times to specific users.

14. A system according to claim 1, wherein the advertisements may be manually turned off by users.

15. A system according to claim 1, wherein a survey may be distributed to gather feedback from users on particular advertisements.

16. A system according to claim 1, further comprising:
an electronic environment wherein schools may auction off advertising space to sponsors.

17. A system according to claim 16, wherein advertising space may be auctioned off as either exclusive or nonexclusive.

18. A system according to claim 16, wherein sponsors may select which schools or school systems they want to advertise at.

19. A system according to claim 16, wherein the revenues from advertising may be collected automatically.

20. A method for delivering advertising to school administrators, teachers, parents, and students comprising:
managing advertisements on a website;
reviewing advertising for appropriate content;
marketing website space to advertisers;
receiving submitted advertisements for publication;
accepting advertisements according to predetermined educational based criteria; and
storing demographical data for all users of the application.

21. A method according to claim 20, wherein the advertisements may be created for sponsors automatically by the application based on the sponsor's responses to predetermined queries.

22. A method according to claim 20, wherein the advertisements submitted are reviewed by a committee.

23. A method according to claim 22, wherein the committee consists of school officials, parents, or other individuals making up a cross-representation of the local population where the advertisements may be viewed.

24. A method according to claim 22, wherein the sponsor is automatically notified of any rejections of their advertisements.

25. A method according to claim 22, wherein the sponsor is automatically notified of any rejections of their advertisements and the reasons for any rejection.

26. A method according to claim 22, wherein any sponsor whose advertisement has been rejected may be given the opportunity to revise and resubmit their advertisement.

27. A method according to claim 20, wherein the demographical data may be shared with sponsors.

28. A method according to claim 20, wherein the demographical data may be used to individualize advertising distributed to specific users or user groups.

29. A method according to claim 20, wherein the demographical data may be used to collect data that measures the success of particular marketing strategies.

30. A method according to claim 20, wherein the demographical data may also include a student's scholastic information.

31. A method according to claim 20, wherein the advertisements may be turned off automatically at predetermined times to specific users.

32. A method according to claim 20, wherein the advertisements may be manually turned off by users.

33. A method according to claim 20, wherein a survey may be distributed to gather feedback from users on particular advertisements.

34. A method according to claim 20, further comprising:
an electronic environment wherein schools may auction advertising space to sponsors.

35. A method according to claim 20, wherein advertising space may be auctioned off as either exclusive or nonexclusive.

36. A method according to claim 20, wherein sponsors may select which schools or school systems they want to advertise at.

37. A method according to claim 20, wherein the revenues from advertising may be collected automatically.
